(19) United States
(12) Patent Application Publication
(10) Pub. No.: US 2013/0146184 A1
(43) Pub. Date: Jun. 13, 2013

(54) IRON- AND NICKEL-BASED BRAZING FOIL AND METHOD FOR BRAZING

(71) Applicants: Thomas HARTMANN, Altenstadt (DE); Dieter Nuetzel, Hainburg (DE)

(72) Inventors: Thomas HARTMANN, Altenstadt (DE); Dieter Nuetzel, Hainburg (DE)

(73) Assignee: VACUUMSCHMELZE GMBH & CO. KG, Hanau (DE)

(21) Appl. No.: 13/760,400

(22) Filed: Feb. 6, 2013

Related U.S. Application Data
(62) Division of application No. 11/990,785, filed on Mar. 5, 2008, now abandoned.

(30) Foreign Application Priority Data
Aug. 22, 2005 (DE) 10 2005 039 803.0

(51) Int. Cl. B23K 31/02

(52) U.S. Cl. CPC B23K 31/02
USPC 148/528; 228/249; 148/561

(57) ABSTRACT

An amorphous, ductile brazing foil is produced with a composition of FeₐNi_{b}Cr_{c}Si_{d}BₑMo_{f}P_{g} with 25≦a≦50 atomic %; 30≦b≦45 atomic %; 5<c≦15 atomic %; 4≦d≦15 atomic %; 4≦e≦15 atomic %; 0≦f≦5 atomic %; 0≦g≦6 atomic %; and any impurities, wherein 10≦d+e+g≦28 atomic % with a+b+c+d+e+f+g=100. Excellent brazing joints can be produced with these brazing foils.

The invention relates to an iron- and nickel-based brazing foil and method for brazing two or more metal components.

Iron-based brazing alloys are for example known from U.S. Pat. No. 4,402,742. Iron-based brazing alloys offer the advantage of being cheaper than nickel-based brazing alloys, as raw material costs are lower. In addition, iron-based alloys can be joined more easily, as the composition of the brazing seam can be matched to the composition of the components to be joined more precisely.

However, known iron-based brazing alloys are crystalline and produced as a powder or a paste. Powders are typically produced by means of the atomisation of a melt. Pastes are produced by mixing the metal powders with organic binders and solvents. A disadvantage of this lies in the fact that the organic components decompose while being heated to brazing temperature, which can affect the flow and wetting properties of the molten brazing alloy.

There is further a risk that the joints may not be completely filled with the brazing alloy, with the result that the mechanical stability of the components to be joined can no longer be reliably ensured. Such joining faults when brazing heat exchangers or similar products are critical for their leak-proofing and may make the use of the heat exchanger impossible.

These problems can be avoided by using brazing alloys in the form of homogeneous and ductile foils. Up to now it has however not been possible to produce iron- and nickel-based brazing alloys as ductile foils.

The present invention is therefore based on the problem of providing an iron-based brazing alloy in the form of a ductile foil and of specifying a brazing method using a ductile brazing foil of this type, which offers good flow and wetting properties and thus ensures a faultless brazing joint. In addition, the brazing alloy should be capable of being produced as a rapidly solidifying foil within a wide range of thicknesses and widths to enable it to meet the technical requirements of a variety of applications.

According to the invention, this problem is solved by an amorphous, ductile brazing foil of a composition consisting essentially of

FeₐNi_{b}Cr_{c}Si_{d}BₑMo_{f}P_{g}

with 25≦a≦50 atomic %; 25≦b≦50 atomic %; 5<c≦15 atomic %; 4≦d≦15 atomic %; 4≦e≦15 atomic %; 0≦f≦5 atomic %; 0≦g≦6 atomic %; and any impurities, wherein 10≦d+e+g≦28 atomic % with a+b+c+d+e+f+g=100.

Compared to nickel-based brazing alloys, the higher iron content and the lower nickel content result in a reduction of raw material costs. The brazing foils according to the invention are therefore cost-effective and suitable for industrial use. The brazing alloy preferably has an Ni content of 30≦b≦45 atomic %.

The chromium content provides for good corrosion resistance, so that the brazed joint can be used for operation in corrosive media. The ductility of nickel-based brazing alloys worsens with increasing chromium content. In the brazing foil according to the invention, however, a chromium content of 5 to 15 atomic % can be added without any significant reduction of ductility.

The composition of the brazing alloy according to the invention is further selected such that the alloy can be produced as a ductile, amorphous foil. The foil is preferably produced by means of rapid solidification processes.

The elements boron, silicon and phosphorus are metalloids and gas-forming elements. A higher content of these elements leads to a reduction of melting or liquidus temperature. If the content of gas-forming elements is too low on the one hand, the foils solidify to become crystalline and very brittle. If the content of gas-forming elements is too high on the other hand, the foils are brittle in very thin strips and can no longer be used for technical processes.

The metalloid content is further selected such that the seam produced from the brazing foil has suitable mechanical properties. A high B content results in the precipitation of B hard phases in the brazing seam and in the base material, which affects the mechanical properties of the brazed composite. In this process, boron reacts with chromium, which likewise results in a significant reduction of corrosion resistance. A higher Si content leads to the formation of undesirable Si hard phases in the brazing seam, which results in a reduction of the strength of the seam.

The brazing foil according to the invention therefore has a composition wherein the content of gas-forming elements amounts to a total of 10 to 28 atomic % of the alloy. Brazing alloys with this composition can be produced as ductile, amorphous foils by means of rapid solidification.

For the above reasons the B content lies in the range of 4 to 15 atomic %, preferably 4 to 12 atomic %, while the Si content lies in the range of 4 to 15 atomic %, preferably 5 to 13 atomic %.

The brazing alloy according to the invention has a liquidus temperature of less than 1200° C. This is desirable, because the maximum temperature for many industrial brazing processes, in particular for joining stainless steel base materials, is limited to approximately 1200° C. As a rule, the brazing temperature is required to be as low as possible, as an undesirable coarse grain formation of the base material tends to start at temperatures from 1000° C. This undesirable coarse grain formation reduces the mechanical strength of the base material, which is critical in many technical applications, such as heat exchangers. This problem is significantly reduced in brazing alloys according to the invention.

It has been found that the melting temperature of an alloy with a nickel content of 25 to 50 atomic % and an Fe content of 25 to 50 atomic % lies below 1200° C. Owing to the nickel content, the content of gas-forming elements can be reduced. This avoids the disadvantage of B and Si hard phase formation, because the metalloid content can be reduced.

The brazing alloys according to the invention are therefore suitable for industrial applications where the maximum brazing temperature is limited to 1200° C. They offer a reliable brazing joint.

The brazing alloys according to the invention are preferably produced as homogeneous, ductile, amorphous brazing foils, which are typically 50% and preferably more than 80% amorphous.

The brazing foils according to the invention are characterised by an excellent flow and wetting behaviour, allowing the reliable completion of fillet welds and faultless joints. This ensures the mechanical stability of the brazing joint and increases the number of possible applications for the brazing foils according to the invention.

At an identical metalloid content, the ductile brazing foils according to the invention can be produced in significantly thicker and wider strips. The brazing alloys according to the invention are therefore perfectly suitable for casting in thicknesses of more than 30 μm, preferably 40 μm D 80 μm, and in widths of more than 40 mm, preferably 20 mm B 300 mm, which has been possible only to a limited extent with alloys of prior art.

At an identical metalloid content, the brazing foils according to the invention with a nickel content above 25 atomic % have better ductility limits than brazing alloys with a nickel content of less than 20 atomic %. It is therefore possible to produce thicker brazing foils which easily meet all technical requirements of a variety of applications. With brazing alloys according to the invention, strip thicknesses of at least 30 μm can be produced, which are required in a great number of technical applications.

The invention further provides a heat exchanger. The heat exchanger has at least one brazing seam produced with a brazing foil of a composition consisting essentially of

FeₐNi_{b}Cr_{c}Si_{d}BₑMo_{f}P_{g}

with 25≦a≦50 atomic %; 25≦b≦50 atomic %; 5<c≦15 atomic %; 4≦d≦15 atomic %; 4≦e≦15 atomic %; 0≦f≦5 atomic %; 0≦g≦6 atomic %; and any impurities, wherein 10≦d+e+g≦28 atomic % with a+b+c+d+e+f+g=100. The brazing seam is produced using an amorphous, ductile brazing foil. In a further embodiment, the Ni content lies in the range of 30≦b≦45 atomic %. As an alternative, the heat exchanger may have a brazing seam made of an amorphous, ductile brazing foil according to any of the preceding embodiments.

The brazing seam made of an amorphous, ductile brazing foil differs from a brazing seam produced using a crystalline powder in the size of the B and Si hard phases.

The invention further provides a method for joining two or more metal components by adhesive force, which comprises the following steps. An amorphous, ductile brazing foil according to any of the preceding embodiments is introduced between two or more metal components to be joined. The metal components to be joined have a higher melting temperature than the brazing foil and may for example consist of stainless steel, an Ni or Co alloy. The composite to be brazed is heated to a temperature above the liquidus temperature of the brazing foil and then cooled while forming a brazing joint between the metal components to be joined.

The metal components to be joined are preferably components of a heat exchanger, an exhaust gas recirculation cooler or a fuel cell. These products require a reliable brazing joint which is completely leak-proof, resistant to corrosion at elevated operating temperatures, mechanically stable and therefore reliable. The brazing foils according to the invention make such a joint available.

The brazing foils according to the invention can be used to produce one or more brazing seams in an object. The brazed object may for example be used as a heat exchanger, an exhaust gas recirculation cooler or a fuel cell.

The brazing foils according to the invention are produced as amorphous, homogeneous and ductile brazing foils in a rapid solidification process. For this purpose, a metal melt is sprayed through a casting nozzle onto a high-speed casting wheel or casting drum and cooled at a rate of more than 10⁵° C./s. The cast strip is then typically removed from the casting wheel at a temperature between 100° C. and 300° C. and directly wound to form a so-called coil or wound onto a reel.

The amorphous brazing foils according to the invention are used for joining two or more metal components by adhesive force, involving the following steps:
Provision of a melt consisting of FeₐNi_{b}Cr_{c}Si_{d}BₑMo_{f}P_{g} with 25≦a≦50 atomic %; 25≦b≦50 atomic %; 5<c≦15 atomic %; 4≦d≦15 atomic %; 4≦e≦15 atomic %; 0≦f≦5 atomic %; 0≦g≦6 atomic %; and any impurities, wherein 10≦d+e+g≦28 atomic % with a+b+c+d+e+f+g=100;
Production of an amorphous brazing alloy foil by rapid solidification of the melt on a moving cooling surface at a rate of more than approximately 10⁵° C./s;
Formation of a brazing composite by applying the brazing alloy foil between the metal components to be joined;
Heating of the brazing composite to a temperature above the liquidus temperature of the brazing alloy foil;
Cooling of the brazing composite accompanied by the formation of a joint between the metal components to be joined.

In a further embodiment, a melt consisting of FeₐNi_{b}Cr_{c}Si_{d}Bₑ₋Mo_{f}P_{g} with 25≦a≦50 atomic %; 30≦b≦45 atomic %; 5<c≦15 atomic %; 4≦d≦15 atomic %; 4≦e≦15 atomic %; 0≦f≦5 atomic %; 0≦g≦6 atomic %; and any impurities, wherein 10≦d+e+g≦28 atomic % with a+b+c+d+e+f+g=100, is provided.

The joining by adhesive force as described above involves a brazing process using the iron- and nickel-based brazing alloy according to the invention, whereby perfect brazing joints without any joining faults can be obtained.

The liquidus temperature of the brazing alloy according to the invention is less than 1200° C. The brazing method according to the invention is particularly suitable for joining metal components made of stainless steel and/or nickel and/or Co alloys by adhesive force. Such components are typically used in the production of heat exchangers or similar products (e.g. exhaust gas recirculation coolers).

At brazing temperature, the molten brazing foils wet the metal components to be joined, completely filling the seam owing to their composition according to the invention, so that joining faults are avoided.

The invention is described in detail below with reference to embodiments and comparative examples.

Table 1 lists the solidus and liquidus temperatures of Fe—Ni brazing foils with different Ni and metalloid contents.

TABLE 1

| | Fe | Ni | Cr | Si | B | Mo | Solidus | Liquidus |
|---|---|---|---|---|---|---|---|---|
| | (at | (at | (at | (at | (at | (at | temperature | tempera- |
| | %) | %) | %) | %) | %) | %) | (° C.) | ture (° C.) |
| 1 | 68 | 10 | 10 | 5 | 7 | 0 | 1130 | 1280 |
| 2 | 66 | 10 | 10 | 5 | 9 | 0 | 1115 | 1225 |
| 3 | 66 | 10 | 10 | 9 | 5 | 0 | 1130 | 1280 |
| 4 | 64 | 10 | 10 | 9 | 7 | 0 | 1110 | 1230 |
| 5 | 62 | 10 | 19 | 5 | 13 | 0 | 1100 | 1215 |
| 6 | 51 | 25 | 19 | 5 | 9 | 0 | 1055 | 1200 |
| 7 | 49 | 25 | 10 | 9 | 7 | 0 | 1100 | 1200 |
| 8 | 49 | 25 | 10 | 5 | 13 | 0 | 1045 | 1195 |
| 9 | 44 | 30 | 10 | 9 | 7 | 0 | 1050 | 1185 |
| 10 | 42 | 30 | 10 | 9 | 9 | 0 | 980 | 1160 |
| 11 | 36 | 40 | 10 | 9 | 5 | 0 | 960 | 1195 |
| 12 | 34 | 40 | 10 | 9 | 7 | 0 | 970 | 1175 |
| 13 | 32 | 40 | 10 | 5 | 13 | 0 | 915 | 1140 |
| 14 | 27 | 40 | 14 | 9 | 9 | 1 | 955 | 1135 |

The brazing foils numbered 1 to 5 do not represent a part of the invention, while the brazing foils numbered 6 to 14 are brazing foils according to the present invention.

The processing temperature and thus the brazing temperature of such brazing foils is typically 10 to 50° C. above liquidus temperature. As table 1 shows, Fe—Ni brazing foils with an Ni content of less than 25 atomic % (numbered 1 to 5 in Table 1) tend to have a liquidus temperature significantly above 1200° C. This results in processing temperatures above 1200° C. for Fe—Ni brazing foils with an Ni content of less than 25 atomic %. These processing temperatures are not acceptable, because they result in coarse grain formation and damage the base material of the components to be joined.

At an identical metalloid content, i.e. Si and B content, Fe/Ni brazing alloys with a higher Ni content of 25 or 40 atomic % (numbered 6 to 14 in Table 1) have a liquidus temperature below the permissible maximum of 1200° C. used in industrial technology. The processing temperature is therefore less than 1200° C., which is acceptable. These alloys can furthermore be produced as amorphous, ductile foils with a strip thickness of more than 30 μm and therefore meet the requirements of industrial applications.

### 1^{st} EMBODIMENT

A brazing seam was produced using a ductile, amorphous brazing foil with a composition of Fe32-Ni40-Cr10-Si9-B9. The brazing conditions were 1190° C. for 30 min. The alloy flowed, wetted the base material and formed an ideally filled fillet weld. The brazing seam did not show any defects in the form of poor fusion.

### 2^{nd} EMBODIMENT

A brazing seam was produced using a ductile, amorphous brazing foil with a composition of Fe62-Ni10-Cr10-Si5-B11. The brazing conditions were 1240° C. for 30 min. The brazing alloy had very poor flow and wetting properties, so that the seam was not filled completely. The joint was characterised by very poor fusion. A reliable joint could not be ensured.

1-19. (canceled)

20. A method for joining two or more metal components by adhesive force, comprising:
introducing an amorphous, ductile brazing foil of a composition consisting essentially of
FeₐNi_{b}Cr_{c}Si_{d}BₑMo_{f}P_{g}
wherein 25≦a≦50 atomic %; 25≦b≦50 atomic %; 5<c≦15 atomic %; 4≦d≦15 atomic %; 4≦e≦15 atomic %; 0≦f≦5 atomic %; 0≦g≦6 atomic %;
and any impurities,
wherein 10≦d+e+g≦28 atomic %, and a+b+c+d+e+f+g=100,
between two or more metal components to be joined, wherein the metal components to be joined have a higher melting temperature than the brazing foil to form a brazing composite;
heating the brazing composite to a temperature above the liquidus temperature of the brazing foil;
cooling the brazing composite, thereby forming a brazing joint between the metal components.

21. The method according to claim 20, wherein the metal components to be joined comprise two or more components of a heat exchanger or an exhaust gas recirculation cooler or a fuel cell.

22. The method according to claim 20, wherein the brazing foil is at least 80% amorphous.

23. The method according to claim 20, wherein the amorphous, ductile brazing foil has a composition consisting essentially of
FeₐNi_{b}Cr_{c}Si_{d}BₑMo_{f}P_{g}
wherein 25≦a≦50 atomic %; 30≦b≦45 atomic %; 5<c≦15 atomic %; 4≦d≦15 atomic %; 4≦e≦15 atomic %; 0≦f≦5 atomic %; 0≦g≦6 atomic %;
and any impurities,
wherein 12≦d+e+g≦24 atomic %, and a+b+c+d+e+f+g=100
wherein the brazing foil has a width ranging from 20 mm to 350 mm.

24. The method according to claim 20, wherein the amorphous, ductile brazing foil has a Si content such that 5≦d≦13 atomic %.

25. The method according to claim 20, wherein the amorphous, ductile brazing foil has a B content such that 4≦e≦12 atomic %.

26. The method according to claim 20, wherein the amorphous, ductile brazing foil has a liquidus temperature of less than 1195° C.

27. The method according to claim 20, wherein the amorphous, ductile brazing foil has a thickness D of more than 30 μm.

28. The method according to claim 20, wherein the amorphous, ductile brazing foil has a thickness D, such that 40 μm≦D≦80 μm.

29. The method according to claim 20, wherein the amorphous, ductile brazing foil has a width B≦40 mm.

30. The method according to claim 20, wherein the two or more metal components form part of an apparatus that is a heat exchanger, an exhaust gas recirculation cooler, or a fuel cell.

31. The method according to claim 30, wherein the apparatus is a heat exchanger.

32. The method according to claim 20, wherein the brazing joint comprises a seam that has a thickness D>30 μm.

33. The method according to claim 20, wherein at least one of said two or more metal parts comprises a metal component made from stainless steel, nickel alloy, cobalt alloy, or a combination thereof.

34. A method for joining two or more metal components by adhesive force, comprising:
providing a melt of FeₐNi_{b}Cr_{c}Si_{d}BₑMo_{f}P_{g} wherein 25≦a≦50 atomic %; 25≦b≦51 atomic %; 5<c≦15 atomic %; 4≦d≦15 atomic %; 4≦e≦15 atomic %; 0≦f≦5 atomic %; 0≦g≦6 atomic %; and any impurities, wherein 10≦d+e+g≦28 atomic % with a+b+c+d+e+f+g=100;
producing an amorphous brazing alloy foil by rapid solidification of the melt on a moving cooling surface at a cooling rate of more than approximately 10⁵° C./s;
forming a brazing composite by applying the brazing alloy foil between metal components;
heating at least a portion of the brazing composite to a temperature above the liquidus temperature of the brazing alloy foil;
cooling the brazing composite, thereby forming a brazing joint between the metal components.

35. A method for joining two or more metal components by adhesive force, comprising:
providing a melt of FeₐNi_{b}Cr_{c}Si_{d}BₑMo_{f}P_{g} wherein 25≦a≦50 atomic %; 30≦b≦45 atomic %; 5<c≦15 atomic %; 4≦d≦15 atomic %; 4≦e≦15 atomic %; 0≦f≦5 atomic %; 0≦g≦6 atomic %; and any impurities, wherein 10≦d+e+g≦28 atomic % with a+b+c+d+e+f+g=100;
producing an amorphous brazing alloy foil by rapid solidification of the melt on a moving cooling surface at a cooling rate of more than approximately 10⁵° C./s;
forming a brazing composite by applying the brazing alloy foil between metal components;
heating the brazing composite to a temperature above the liquidus temperature of the brazing alloy foil;
cooling the brazing composite, thereby forming a joint between the metal components.

36. A method for producing an amorphous, ductile brazing foil, comprising:
providing a melt of FeₐNi_{b}Cr_{c}Si_{d}BₑMo_{f}P_{g} wherein 25≦a≦51 atomic %; 25≦b≦50 atomic %; 5<c≦15 atomic %; 4≦d≦15 atomic %; 4≦e≦15 atomic %; 0≦f≦5 atomic %; 0≦g≦6 atomic %; and any impurities, wherein 10≦d+e+g≦28 atomic % with a+b+c+d+e+f+g=100; and
rapidly solidifying the melt on a moving cooling surface at a cooling rate of more than approximately 10⁵° C./s to produce an amorphous brazing alloy foil.

37. The method of claim 28, wherein Ni is present in an amount such that 30≦b≦45 atomic %.
